(19) United States
(12) Patent Application Publication
(10) Pub. No.: US 2024/0404356 A1
(43) Pub. Date: Dec. 5, 2024

(54) System and Method for Distributed Voucher Validation

(71) Applicant: Grover Gaming, Inc., Greenville, NC (US)

(72) Inventor: Anthony R. Antonucci, Lake Zurich, IL (US)

(73) Assignee: Grover Gaming, Inc., Greenville, NC (US)

(21) Appl. No.: 18/676,685

(22) Filed: May 29, 2024

Related U.S. Application Data
(60) Provisional application No. 63/469,581, filed on May 30, 2023.

(51) Int. Cl. G07F 17/32; G07F 17/34

(52) U.S. Cl. CPC G07F 17/3241; G07F 17/3223; G07F 17/3244; G07F 17/34

(57) ABSTRACT

A distributed verification system including a server, a controller, operating memory, and a communications interface, accessible via a network. The system may include a database; one or more devices, including a communications interface and an internal voucher table; and one or more processors. The devices are in communication with the server and one another. The system may issue a voucher including a unique validation ID from the devices on the network; communicate and store state information of the issued voucher to the internal table of the devices; receive an issued voucher for redemption at any one of the devices on the network; communicate and store state information of the redeemed voucher to the internal table of one or more of the devices on the network; and communicate state information of all issued and/or redeemed vouchers to the server from one or more of the devices on the network.

### RELATED APPLICATIONS

This application is related and claims priority to U.S. Provisional Patent Application No. 63/469,581, filed on May 30, 2023 the application of which is incorporate herein by reference in its entirety.

### TECHNICAL FIELD

The subject matter of the disclosed invention relates generally to distributed voucher validation and more particularly to a distributed voucher validation in a gaming establishment.

### BACKGROUND

In a typical gaming establishment where a vouchering system is in use (sometimes called Ticket-in/Ticket-out), at any one time there are some number of live (issued but not redeemed) vouchers in existence in the gaming establishment. Especially at large and busy gaming establishment there may be a couple hundred vouchers live at any one time. In the typical gaming establishment there is a single-point-of-failure. The host system is responsible for providing unique voucher validation IDs (e.g., 18-digit numbers that get barcoded and printed on each voucher), the electronic gaming machine (hereafter EGM) needs to acquire this unique validation ID from the host system to print a voucher along with the amount of the voucher, its expiration and other data. If the host system is down, the EGM is unable to acquire the required validation ID and issue a voucher, and therefor the EGM is unable to cash out the player. This creates a problem for the gaming establishment and an inconvenience for the players.

Therefore, there is a need for an improved voucher validation system for use in gaming establishments.

### SUMMARY

In one embodiment, a system for distributed voucher verification is provided. The system may include a server; a database in communication with the server; one or more devices; one or more processors; and a non-transitory computer-readable medium storing instructions. The server may include a controller, operating memory, and a communications interface, and the server may be accessible via a network. The one or more devices may each include a communications interface and an internal voucher table. The one or more devices may be in communication with the server and with one another via the network. The instructions stored on the non-transitory computer-readable medium may, when executed by the one or more processors, cause the system to issue a voucher from one of the one or more devices on the network, the voucher comprising a unique validation ID; communicate and store state information of the issued voucher to the internal table of one or more of the one or more devices on the network; receive an issued voucher for redemption at any one of the one or more devices on the network; communicate and store state information of the redeemed voucher to the internal table of one or more of the one or more devices on the network; and communicate state information of all issued and/or redeemed vouchers to the server from one or more of the one or more devices on the network. The one or more devices may include one or more electronic gaming machines (EGMs) and/or one or more point of sale terminals (POSs). The one or more devices each may include an electronic game machine interface board (EGMIB), the EGMIB may include logic, one or more interface boards, a processor, and on board memory, and wherein the EGMIB may be configured to link the one or more devices to the server and to one another. The system of claim 3, wherein the EGMIB may include a slot machine interface board (SMIB). The system may further include a server internal voucher table stored on the server and/or the database. The internal voucher table of each of the one or more devices and/or server may include information of issued and/or redeemed vouchers, wherein the information is of vouchers issued and/or redeemed on any of the one or more of the devices on the network. The one or more devices each may include a set of pre-fetched validation IDs stored thereon, wherein an issued voucher generated while the server is offline is assigned a validation ID from the set of stored pre-fetched validation IDs. The set of pre-fetched validation IDs may be generated by the server and communicated to and stored on the one or more devices upon connection to the server. Upon the server receiving a redeemed voucher state communication from any one or more of the one or more devices, the server may communicate a delete instruction to all the devices on the network, and wherein the redeemed voucher may be removed from the internal voucher tables of all the devices on the network. Only the server communicates the delete instruction. The issued voucher may be a physical voucher dispensed from the one of the one or more devices on the network. The unique validation ID may be printed directly on the physical issued voucher.

In another embodiment, a method of using a system for distributed voucher verification is provided. The method may include providing a distributed verification system; issuing a voucher from one of the one or more devices on the network, wherein the voucher may include a unique validation ID; communicating state information of the issued voucher to one or more of the one or more devices on the network; storing the communicated state information of the issued voucher to the internal table of one or more of the one or more devices on the network; receiving an issued voucher for redemption at one of the one or more devices on the network; communicating state information of the redeemed voucher to one or more of the one or more devices on the network; storing the received state information of the redeemed voucher to the internal table of one or more of the one or more devices on the network; and communicating state information of all issued and/or redeemed vouchers to the server from one or more of the one or more devices on the network. The system may include a server; a database in communication with the server; one or more devices; one or more processors; and a non-transitory computer-readable medium storing instructions. The server may include a controller, operating memory, and a communications interface, and the server may be accessible via a network. The one or more devices may each include a communications interface and an internal voucher table. The one or more devices may be in communication with the server and with one another via the network. The instructions stored on the non-transitory computer-readable medium may, when executed by the one or more processors, cause the system to issue a voucher from one of the one or more devices on the network, the voucher comprising a unique validation ID; communicate and store state information of the issued voucher to the internal table of one or more of the one or more devices on the network; receive an issued voucher for redemption at any one of the one or more devices on the network; communicate and store state information of the redeemed voucher to the internal table of one or more of the one or more devices on the network; and communicate state information of all issued and/or redeemed vouchers to the server from one or more of the one or more devices on the network. Issuing the voucher may include dispensing a physical issued voucher from the issuing device. The unique validation ID may be printed directly on the physical issued voucher. The one or more devices may include one or more electronic gaming machines (EGMs) and/or one or more point of sale terminals (POSs). The one or more devices each may include an electronic game machine interface board (EGMIB), the EGMIB may include logic, one or more interface boards, a processor, and on board memory, and wherein the EGMIB may be configured to link the one or more devices to the server and to one another The EGMIB may include a slot machine interface board (SMIB). The method may further include a server internal voucher table that is stored on the server and/or the database. The internal voucher table of each of the one or more devices and/or server may include information of issued and/or redeemed vouchers, wherein the information is of vouchers issued and/or redeemed on any of the one or more of the devices on the network. The one or more devices each may include a set of pre-fetched validation IDs stored thereon, wherein an issued voucher generated while the server is offline is assigned a validation ID from the set of stored pre-fetched validation IDs. The set of pre-fetched validation IDs is generated by the server and communicated to and stored on the one or more devices upon connection to the server. Upon the server receiving a redeemed voucher state communication from any one or more of the one or more devices, the server may communicates a delete instruction to all the devices on the network, and wherein the redeemed voucher may be removed from the internal voucher tables of all the devices on the network. Only the server communicates the delete instruction.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a typical prior art voucher validation system;

FIG. 2 illustrates a block diagram of an example of a distributed voucher validation system, in accordance with an embodiment of the invention;

FIG. 3 illustrates a state diagram of an example distributed voucher validation system, in accordance with an embodiment of the invention;

FIG. 4 illustrates an example decision map of an example distributed voucher validation system, in accordance with an embodiment of the invention;

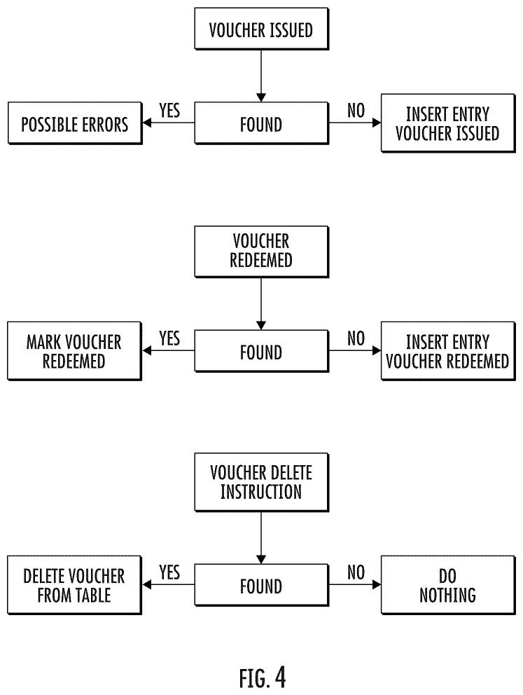

FIG. 5 illustrates an example data flow diagram of an example distributed voucher validation system, in accordance with an embodiment of the invention; and

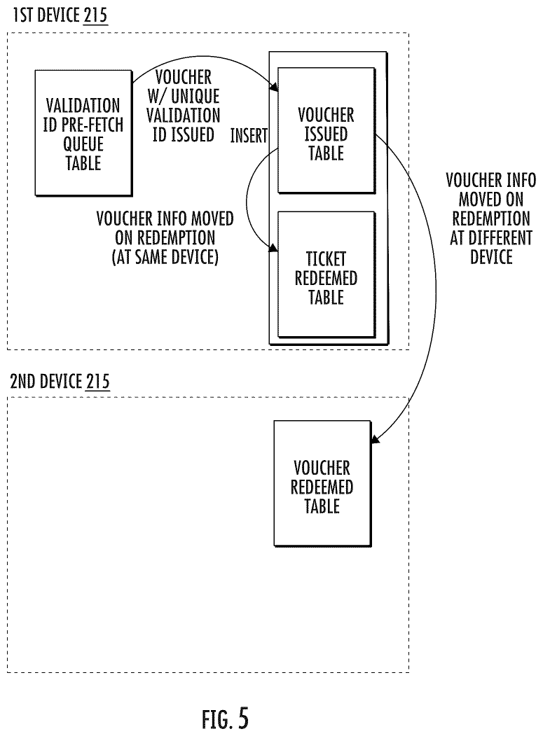

FIG. 6 illustrates an example sequence flow diagram of an example distributed voucher validation system, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a distributed voucher (ticket) validation system where all devices on the network maintain an internal table of voucher information so, if the host system is offline, any device can validate any live voucher in its internal table and then communicate the new status of that voucher to all devices on the network.

In some embodiments, the subject matter of the invention provides a distributed voucher validation system that when the host system returns online, the devices that redeemed vouchers sends that information to the host system and may be persisted in the database.

In some embodiments, the subject matter of the invention provides a distributed voucher validation system that when the host system receives and successfully persists (writes) any redeemed voucher(s) received from the devices, it communicates a delete message to all the devices on the network, so they can remove that redeemed and completed voucher from their internal voucher table.

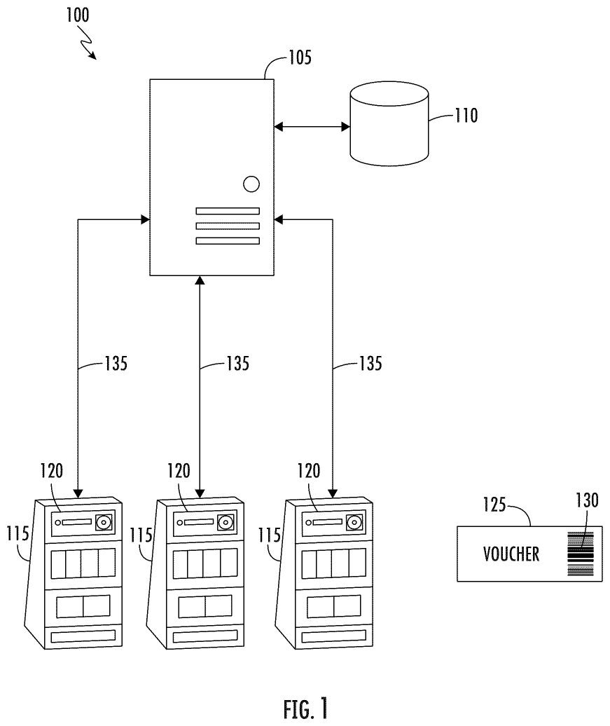

Referring now to FIG. 1 illustrates a block diagram of an example of a typical prior art voucher validation system 100. A typical gaming establishment includes a host server 105, which is typically a back-office device that includes a database 110 used for gaming functions and reporting. The typical prior art voucher validation system 100 includes one or more electronic gaming machines (EGM) 115, which can be slot machines, electronic table games, ticket redeem and/or the like. The typical prior art voucher validation system 100 may include one or more electronic game machine interface boards (EGMIB) 120, e.g., slot machine interface boards (SMIB), which may be a hardware device that links an EGM 115 to the host server 105. Typically, there may be one EGMIB 120 located inside the cabinet of each EGM 115, so the EGMIB 120 and EGM 115 are often referred to as one logical device that consists of two physical devices, i.e., the EGM 115 and EGMIB 120, (referred to collectively herein as EGM 115 for simplicity). The typical prior art voucher validation system 100 may also include a point of sale terminal (POS) (not shown) and/or ticket/voucher redemption kiosk (not shown), which is the terminal which is typically located in the “cage” where players perform various functions dealing with cash, such as redeem a voucher 125, cash in chips, and/or the like.

In the prior art voucher validation system 100, each EGM 115 communicates only to the host server 105. For example, when a player cashes out at an EGM 115, a request for a unique validation ID 130 is made to the host server 105, which returns the unique validation ID 130. The EGM 115 then prints the voucher 125 with the unique validation ID 130 on it and also sends the validation ID 130, the amount of the voucher 125, and the expiration date to the host server 105 and the information is stored in the database 110. At this point the voucher 125 is now: “issued” (or “live”).

When the player inserts the issued/live voucher 125 into another EGM 115, the EGM 115 sends the validation ID 130 to the host server 105. The host server 105 returns information about the voucher 125, e.g., if it's valid, the amount, and the expiration date. If the voucher 125 is valid, the EGM 115 credits the player and informs the host server 105 that it has accepted the voucher 125. The host server 105 updates the status of the voucher 125 in the database 110. The voucher 125 is now: “redeemed”.

In the prior art voucher validation system 100, each EGM 115 communicates only to the host server 105, as shown by arrows 135, and do not communicate with one another. Therefore, if the connection from the EGM 115 to the host server 105 is broken, vouchers 125 can neither be issued or redeemed, which causes a number of problems, including for example extra work for the floor attendants and inconvenience for the players, and the possibility for fraud.

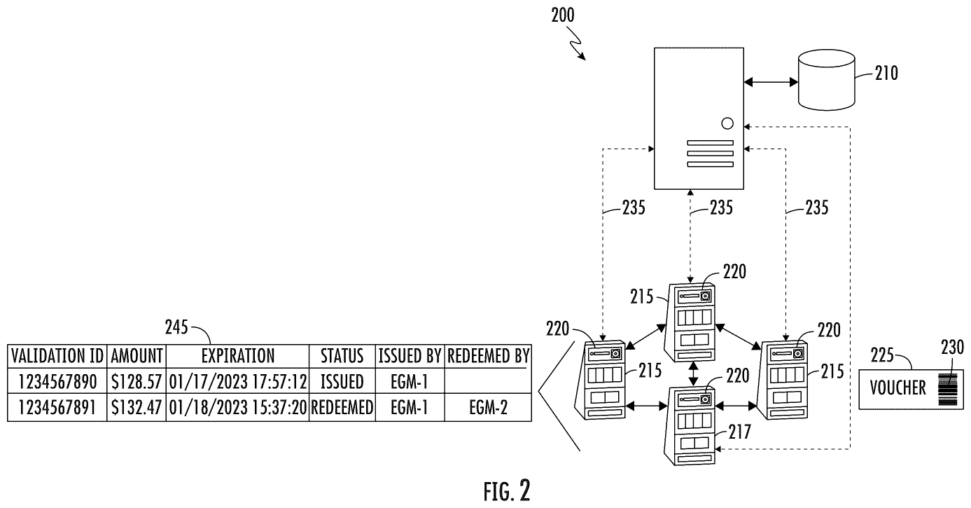

Referring now to FIG. 2, which illustrates an example block diagram of an example of a distributed voucher validation system 200, in accordance with an embodiment of the invention. The distributed voucher validation system 200, may include a host server 205 and a database 210. The distributed voucher validation system 200 may further include one or more electronic gaming machines (EGMs) 215, one or more electronic game machine interface boards (EGMIB) 220, e.g., slot machine interface boards (SMIB), and may include a point of sale terminal(s) (POS) 217, and may further include a voucher redemption kiosk (not shown). The host server 205, in one example, may be a back-office server that includes or is in communication with the database 210, which may be used for gaming functions, reporting, and/or the like. The host server 205 may be a standard server system, and may be local, remote, or cloud-based. The host server 205, in one example, may be the persistent (written) data store for all voucher validation data of the system. The one or more EGMs 215, may be slot machines, electronic table games, and/or the like. The one or more EGMIBs 220 may be a hardware device, which may containing logic and interface boards, and links an EGM 215 (and/or POS 217) to the host server 205, and may include a processor and some amount of on board memory. In one example, there may be one EGMIB 220 located inside a cabinet of each EGM 215 (and/or POS 217). The combined EGMIB 220 and EGM 215 (or POS 217) may be referred to as one logical device that consists of two physical devices, i.e., the EGM 215 and the EGMIB 220, (referred to collectively hereafter as EGM 215 (or POS 217) for simplicity). The POS 217, in one example, may be located in a “cage” where players perform various functions dealing with cash, such as redeem a voucher 225, cash in chips, and/or the like. The POS 217 may be a device on the distributed voucher validation system 200 game network that may redeem a voucher 225 (similar to an EGM 215). The POS 217 may typically be used by a player to redeem vouchers 225 for money, e.g., cashing out. In some embodiments, the POS 217 may also issue vouchers 225, which, in some cases, may be restricted (playable only) vouchers 225.

In the distributed voucher validation system 200, the host server 205 and each EGM 215 (and POS 217) may each include a communications interface (not shown), such that the host server 205 and the EGMs 215 (and POSs 217) that are on the game network may all communicate with one another. That is, in addition to the host server 205 and the EGM's 215 (and POSs 217) being able to communicate with each other (as shown for example by arrows 235), all the EGMs 215 (and POSs 217) on a game network may also communicate with each other (as shown for example by arrows 240). In one example, each EGM 215 (and POS 217) may communicate with the other EGMs 215 (and/or the host server 205 and/or POSs 217) via broadcast, multicast, and/or any other suitable wired and/or wireless technology, technique, and/or mechanism. In one example, the distributed voucher validation system 200 may use user datagram protocol (UDP) multicast, pragmatic general multicast, internet group management protocol (IGMP) snooping, and/or the like for broadcasting/communicating between all the devices on the game network (e.g., EGMs 215, host server 205, and POSs 217).

The host server 205 and the one or more EGMs 215 (and POSs 217) may be networked together, for example, via a local area network (LAN) and/or a wide area network (WAN) for connecting to the Internet or to an Intranet. Host server 205 and the one or more EGMs 215 (and POSs 217) may connect to the network by any wired and/or wireless means. For example, host server 205 and the one or more EGMs 215 (and POSs 217) may connect to the network via their respective communications interfaces, which may be any wired and/or wireless communication interface for connecting to a network and by which information may be exchanged with other devices connected to the network (e.g., host server 205, EGMs 215, and/or POSs 217). Examples of wired communication interfaces may include, but are not limited to, USB ports, RS232 connectors, RJ45 connectors, Ethernet, and/or any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and/or other types of wireless networking protocols.

In one example, the one or more EGMs 215 (and POSs 217) may each further include an internal voucher table 245, which may include information of issued and/or redeemed vouchers 225, which may include the information of vouchers issued and/or redeemed on that particular EGM 215 or on some or all the EGMs 215 (and POSs 217) on the same game network. The host server 205 may also have an internal voucher table 245. In one example, when the host server 205 processes a voucher 225 from its internal voucher table 245 table and persists (writes) it to its database, host server 205 may then delete that voucher 225 from its internal voucher table 245 and may communicate a delete command to the EGMs 215 (and POSs 217) on the game network. In one embodiment, the host server 205 may be the only device in the distributed voucher validation system 200 game network that may delete any voucher 225 records from the internal voucher table 245 of any or all the devices (e.g., EGMs 215 and/or POSs 217) on the same game network. The host server 205, with database 210, may retain all the voucher information for persistent storage and reporting. The EGMs 215 (and POSs 217) may, for example, only contain live vouchers 225 and redeemed vouchers 225 that have not yet been persisted to database 210.

In one embodiment, when an EGM 215 (and/or POS) first connects to the host server 205, e.g., on startup, the host server 205 may generate a set of unique validation IDs (i.e., pre-fetched validation IDs 230) and communicates them to the EGM 215 (and/or POS 217). In one non-limiting example, the set may include ten (10) unique pre-fetched validation IDs 230. The EGM 215 (and/or POS 217) persist these pre-fetched validation IDs 230, e.g., to their internal voucher table 245, so they can issue vouchers 225 even if the host system 205 is offline at that moment. That is, if the host server 205 goes offline, the EGM 215 (and/or POS 217) can print, for example, up to ten (10) vouchers 225. In the distributed voucher validation system 200, if the host server 205 is offline (or goes offline) and a player cashes-out at the EGM 215 they are playing on, a pre-fetched validation ID 230 may be issued. The EGM 215 then may print a voucher 225 with the pre-fetched validation ID 230 on it, and communicates the validation ID 230, and associated information of the voucher 225, which may include the amount of the voucher 225, the expiration date, status, issued/redeemed by, etc., to all the other EGMs 215 (and POSs 217) on the game network. The voucher 225 may now be considered: “issued” (or “live”). If the player inserts or otherwise presents the issued/live voucher 225 into or to another EGM 215 (or POS 217), that EGM 215 (or POS 217) now already has the information from the issued voucher 225, and is able to “redeem” the voucher 225 and send the redemption information to all the other EGMs 215 (and POSs 217) on the game network, while the host server 205 is offline. The voucher 225 may now be considered: “redeemed”.

In the distributed voucher validation system 200, when the previously offline host server 205 comes back online, the EGMs 215 (and POSs 217), in one example, may automatically reconnect with the host server 205 and communicate any offline transactions (i.e., issued and/or redeemed voucher 225 information), to the host server 205. In one alternate example, when the previously offline host server 205 comes back online it may randomly (or non-randomly) pick a device (EGM 215 or POS 217) that is on the game network and send a request message to that device to for its current internal voucher table 245 information. Once the host server 205 has processed and persisted any redeemed voucher 225 to the database 210 (i.e., writes the redeemed voucher 225 information to its database 210), the host server 205 may communicate a delete message for that redeemed voucher 225 to all the EGMs 215 (and POSs 217) on the game network and the redeemed voucher 225 may then be removed from the internal voucher tables 245 of the EGMs 215 (and POSs 217) on the game network. In one embodiment, only the host server 205 may communicate a delete message for a redeemed voucher to be removed from the internal voucher table 245 of the one or more EGMs 215 (and POSs 217) on the game network.

In one embodiment every EGM 215 (and POS 217) on the same game network may have a list of all other EGMs 215 (and POSs 217) on that game network. In one example, each EGM 215 (and/or POS 217) may be associated with a “buddy” EGM 215 (and/or POS 217), and may communicate with that buddy EGM 215 (and/or POS 217) to send any current voucher information/status from its internal voucher table 245.

In another embodiment, when redemption of a voucher 225 is requested at a particular EGM 215 (or POS 217) it may communicate to all the devices (e.g., EGMs 215, POS 217, and/or host server 205) on the game network to query if any other device on the game network has the subject voucher 225 as redeemed, and if it does then that device would immediately respond with that information. If a redemption is requested for a particular voucher 225 and the redemption device (e.g., EGM 215, POS 217, or host server 205), does not have that particular voucher 225 in its list, it would broadcast requesting the voucher 225 information.

In one embodiment, when an EGM 215 (or POS 217) issues a voucher 225 it may send the information for the voucher 225 directly to the host server 205, and adds the newly issued voucher 225 and its associated information, to the internal voucher table 245 of the issuing EGM 215 (or POS 217) (See, for example, Table 1), and may also communicate the information of the issued voucher 225 out to all other EGMs 215 (and POSs 217) on the game network, so the other EGMs 215 (and POSs 217) can add the information of the issued voucher 225 to their internal voucher tables 245. Since the host server 205 may become unavailable at any time, all EGMs 215 (and POSs 217) on the game network are preferably kept updated of any issued and/or redeemed vouchers 225.

TABLE 1
Voucher Table

| | | | | | |
|---|---|---|---|---|---|
| Validation ID | Amount | Expiration | Status | Issued by | Redeemed by |

| | | | | |
|---|---|---|---|---|
| 123456789012345678 | $128.57 | 01/17/2023 17:57:12 | Issued | EGM-1 |

In the distributed voucher validation system 200, once a voucher 225 has been issued and stored in the internal voucher table 245 of the EGMs 215 (or POS 217) on the game network, when a request is made to redeem the issued voucher 225 at any of the EGMs 215 (or POS 217) on the game network, the redeeming EGM 215 (or POS 217) changes the status of the issued voucher 225 to redeemed in its internal voucher table 245 (See, Table 2), and communicates the redemption status to all other EGMs 215 (and POSs 217) on the game network, so they can update their internal voucher tables 245.

TABLE 2
EGM 2

| Validation ID | Amount | Expiration | Status | Issued by | Redeemed by |
|---|---|---|---|---|---|
| 123456789012345678 | $128.57 | 01/17/2023 17:57:12 | Issued | EGM-1 | EGM-2 |

If the host server 205 is available, the EGM 215 (or POS 217) also sends the redemption information to the host server 205. Once the host server 205 receives and successfully persists the redeemed voucher 225, the host server 205 may communicate a delete message to all the EGMs 215 (and POSs 217) on the game network, and the redeemed voucher 225 is removed from their internal voucher tables 245.

In one embodiment, when a new, or previously offline, EGM 215 (or POS 217) comes online, it may communicate a request for an update of its internal voucher table 245. In one example, a single previously existing (online) EGM 215 (or POS 217) on the game network may send its entire internal voucher table 245 to the EGM 215 (or POS 217) that just joined the network (came online). In one example, to prevent all the existing EGMs 215 (or POSs 217) from sending their internal voucher tables 245, each EGM 215 (or POS 217) may wait a small amount of time (which may be random) to broadcast their internal voucher tables 245. When the other EGMs 215 (or POSs 217) receive the response from the first to send EGM 215 (or POS 217), they may cancel their own pending voucher table 245 broadcast. In another example, each previously existing EGM 215 (or POS 217) may send only information for the voucher(s) 225 that it issued or redeemed. This would eliminate duplicate voucher data being sent to the EGM 215 (or POS 217) that just joined the network.

In one embodiment, when the previously offline host server 205 comes back online, all the EGMs 215 (and POSs 217) on the game network may resend all transactions (issued and/or redeemed vouchers 225) that were stored on the internal voucher tables 245 of those EGMs 215 (and POSs 217) during the period the host server 205 was offline. When the host server 205 successfully processes a voucher 225 redemption, it may communicate a delete message for that voucher 225 to all of the EGMs 215 (and POSs 217) on the game network, and the EGMs 215 (and POSs 217) may remove that voucher 225 information from their internal voucher tables 245. This keeps only live vouchers 225 in the voucher tables 245 of the EGMs 215 (and POSs 217), thus keeping the data stored on the internal voucher tables 245 as small as possible.

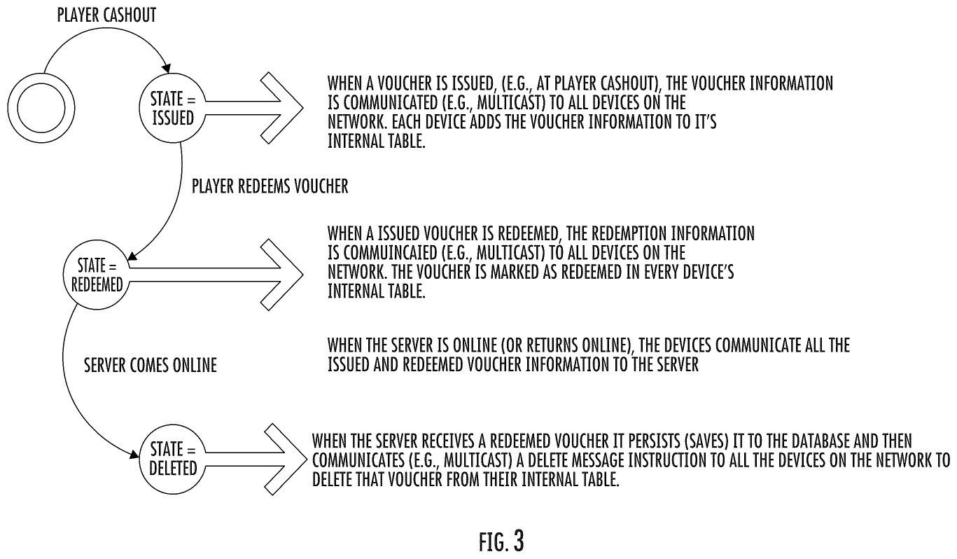

Referring now to FIG. 3 illustrates an example state diagram of voucher 225 states in an example distributed voucher validation system 200, in accordance with an embodiment of the invention. When a player cashes-out of a particular EGM 215 (or POS 217) a voucher 225 (with a validation ID 230) may be issued to the player, and the information for the issued voucher 225 may be saved to the internal voucher table 245 of the issuing EGM 225 (or POS 217) and communicated to all the other EGMs 215 (or POSs 217) on the game network, and each EGM 215 (or POS 217) adds the information for the issued voucher 225 to its own internal voucher table 245. If the host server 205 is online, similarly, when a player cashes-out of a particular EGM 215 (or POS 217) a voucher 225 (with a validation ID 230) may be issued to the player, and the information for the issued voucher 225, in addition to being saved to the internal voucher table 245 of the issuing EGM 225 (or POS 217), may also be saved to the internal voucher table 245 of the host server 205 and/or its database 210. Once the host server 205 receives the voucher 225 information, it may persist the voucher 225 information and immediately send a delete message for any completed redeemed voucher 225. When the host server 205 is online the internal voucher tables 245 of the EGMs 215 (and POSs 217) will mostly be issued (un-redeemed) vouchers 225. That way if the host server 205 goes offline all the devices (EGMs 225 and/or POSs 217) on that distributed voucher validation system 200 game network have a complete table (internal voucher table 245) of all the issued/live vouchers 225. In one example, the host server 205 may only persist and delete redeemed vouchers 225.

In one embodiment, when a player redeems an issued voucher 225 at an EGM 215 (or POS 217) the redemption information may be communicated from the redeeming EGM 215 (or POS 217) to all the other EGMs 215 (and POSs 217) on the game network, including the host server 205 if online. The voucher 225 is marked as redeemed in the internal voucher tables 245 of all the EGMs 215 (and POSs 217) on the game network. If the host server 205 is online, after the host server 205 persists the redeemed voucher 225, it will send a delete message to all EGMs 215 (and POSs 217) on the game network for that redeemed voucher 225. By doing this the internal voucher tables 245 are kept as small as possible, and additional after the voucher 225 is redeemed the information for the redeemed voucher 225 may only be needed at the host system 205 for reporting purposes, for example.

When the host server 205 is online (or returns online), the EGMs 215 (and POSs 217) on the game network may communicate all the issued and/or redeemed vouchers 225 information from their internal voucher tables 245 to the host server 105. When the host server 205 receives a redeemed voucher 225 it persists it to the database 210 and may then communicate a delete message to all the EGMs 215 (and POSs 217) on the game network to delete that redeemed voucher 225 from their internal voucher tables 245.

In one example, EGMs 215 (and POSs 217) keep track of vouchers 225 they themselves issue. When another EGM 215 (or POS 217) attempts to redeem a particular voucher 225, that EGM 215 (or POS 217) broadcasts the redemption request, and the EGM 215 (or POS 217) that issued that particular voucher 225 replies with the information for the voucher 225. If the voucher 225 is redeemed successfully, the redeeming EGM 215 (or POS 217) adds the redeemed voucher 225 to the redeemed list of its internal voucher table 245 and communicates to the issuing EGM 215 (or POS 217) to remove the voucher 225 from the issue list of its internal voucher table 245. When the host server 105 returns online, the EGMs 215 (and POSs 217) on the game network communicates their “issue” and “redeem” voucher 225 information to the host server 205. In one example, issued vouchers 225 are sent first, then redeemed vouchers 225.

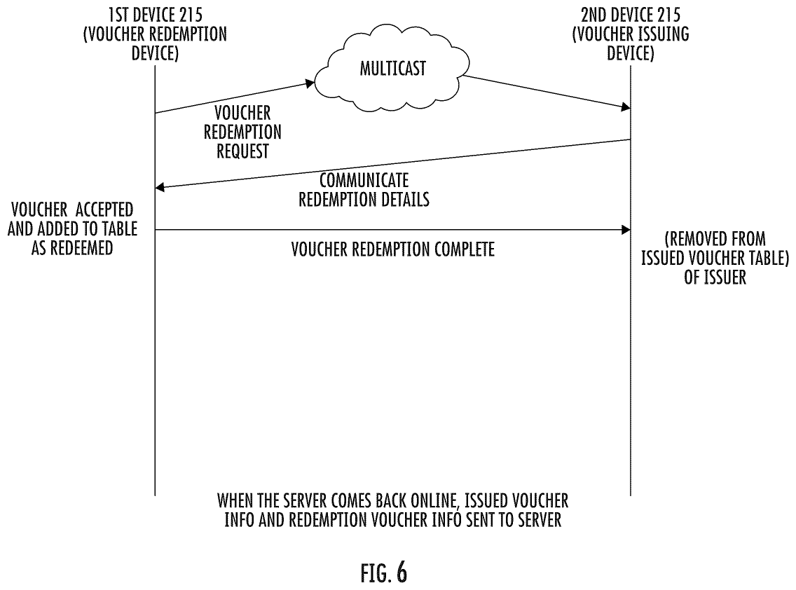

In one example, and with reference to FIG. 6, a first EGM 215 may receive a redemption request for a particular voucher 225 (a player presents/inserts an issued/live voucher 225 in the first EGM 225), and in response the first EGM 215 communicates (e.g., via an IP multicast broadcast) the redemption request to all the other EGMs 215 (and POSs 217) on the game network. A second EGM 215, which originally issued the voucher 225 that is the subject of the redemption request, communicates the redemption details (information associated with the voucher 225) to the first EGM 215. The first EGM 215 accepts the voucher 225 to be redeemed and adds it as redeemed to its internal voucher table 245. The first EGM 215 then communicates to all the other EGMs 215 (and POSs 217) on the game network that the redemption is complete, i.e., the voucher 225 has been redeemed. The second EGM 215 removes the redeemed voucher 225 as being “issued” from its internal voucher table 245. When host server 205 comes back online, the issued and redeemed voucher 225 information are communicated to the host server 205 from the one or more EGMs 215 (or POSs 217).

In summary, the operation of the distributed voucher validation system 200, provides a system and method where all the EGMs 215 (and POSs 217) on a network maintain an internal voucher table 245 of vouchers 225, so, if the host server 205 is, or goes, offline, any EGM 215 (or POS 217) on the network can validate any live voucher 225 in its internal voucher table 245 and communicate the new status of that voucher 225 as issued or redeemed to all EGMs 215 (and POSs 217), preventing a redeemed voucher 225 from potentially being redeemed again. When the host server 205 returns online, the EGMs 215 (and POSs 217) (including all or just those that issued and/or redeemed vouchers 225) may communicate the information to the host server 205. When the host server 205 receives and successfully persists the issued and/or redeemed voucher(s) 225, it can communicate for any redeemed vouchers 225 a delete message to all the EGMs 215 (and/or POSs 217) on the network, so they can remove the redeemed voucher(s) 225 from their internal voucher tables 245.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A distributed verification system comprising:
a. a server, the server including a controller, operating memory, and a communications interface, wherein the server is accessible via a network;
b. a database in communication with the server;
c. one or more devices, the one or more devices each including a communications interface and an internal voucher table, wherein the one or more devices are in communication with the server and with one another via the network;
d. one or more processors; and
e. a non-transitory computer-readable medium storing thereon instructions that, when executed by the one or more processors, cause the system to:
i. issue a voucher from one of the one or more devices on the network, the voucher comprising a unique validation ID;
ii. communicate and store state information of the issued voucher to the internal table of one or more of the one or more devices on the network;
iii. receive an issued voucher for redemption at any one of the one or more devices on the network;
iv. communicate and store state information of the redeemed voucher to the internal table of one or more of the one or more devices on the network; and
v. communicate state information of all issued and/or redeemed vouchers to the server from one or more of the one or more devices on the network.

2. The system of claim 1, wherein the one or more devices comprise one or more electronic gaming machines (EGMs) and/or one or more point of sale terminals (POSs).

3. The system of claim 1, wherein the one or more devices each comprise an electronic game machine interface board (EGMIB), the EGMIB comprising logic, one or more interface boards, a processor, and on board memory, and wherein the EGMIB is configured to link the one or more devices to the server and to one another.

4. The system of claim 3, wherein the EGMIB comprises a slot machine interface board (SMIB).

5. The system of claim 1, further comprising a server internal voucher table stored on the server and/or the database.

6. The system of claim 5, wherein the internal voucher table of each of the one or more devices and/or server comprises information of issued and/or redeemed vouchers, wherein the information is of vouchers issued and/or redeemed on any of the one or more of the devices on the network.

7. The system of claim 1, wherein the one or more devices each comprise a set of pre-fetched validation IDs stored thereon, wherein an issued voucher generated while the server is offline is assigned a validation ID from the set of stored pre-fetched validation IDs.

8. The system of claim 7, wherein the set of pre-fetched validation IDs is generated by the server and communicated to and stored on the one or more devices upon connection to the server.

9. The system of claim 1, wherein upon the server receiving a redeemed voucher state communication from any one or more of the one or more devices, the server communicates a delete instruction to all the devices on the network, and wherein the redeemed voucher is removed from the internal voucher tables of all the devices on the network.

10. The system of claim 9, wherein only the server communicates the delete instruction.

11. The system of claim 1, wherein the issued voucher comprises a physical voucher dispensed from the one of the one or more devices on the network.

12. The method of claim 11, wherein the unique validation ID is printed on the physical issued voucher.

13. A method of using a distributed verification system comprising:
a. providing a distributed verification system, the system comprising:
i. a server, the server including a controller, operating memory, and a communications interface, wherein the server is accessible via a network;
ii. a database in communication with the server;
iii. one or more devices, the one or more devices each including a communications interface and an internal voucher table, wherein the one or more devices are in communication with the server and with one another via the network;
iv. one or more processors; and
v. a non-transitory computer-readable medium storing thereon instructions that, when executed by the one or more processors, cause the system to:
A. issue a voucher from one of the one or more devices on the network, the voucher comprising a unique validation ID;
B. communicate and store state information of the issued voucher to the internal table of one or more of the one or more devices on the network;
C. receive an issued voucher for redemption at any one of the one or more devices on the network;
D. communicate and store state information of the redeemed voucher to the internal table of one or more of the one or more devices on the network; and
E. communicate state information of all issued and/or redeemed vouchers to the server from one or more of the one or more devices on the network;
b. issuing a voucher from one of the one or more devices on the network, wherein the voucher comprising a unique validation ID;
c. communicating state information of the issued voucher to one or more of the one or more devices on the network;
d. storing the communicated state information of the issued voucher to the internal table of one or more of the one or more devices on the network;
e. receiving an issued voucher for redemption at one of the one or more devices on the network;
f. communicating state information of the redeemed voucher to one or more of the one or more devices on the network;
g. storing the received state information of the redeemed voucher to the internal table of one or more of the one or more devices on the network; and
h. communicating state information of all issued and/or redeemed vouchers to the server from one or more of the one or more devices on the network.

14. The method of claim 13, wherein issuing the voucher comprises dispensing a physical issued voucher from the issuing device.

15. The method of claim 13, wherein the unique validation ID is printed on the physical issued voucher.

16. The method of claim 13, wherein the one or more devices comprise one or more electronic gaming machines (EGMs) and/or one or more point of sale terminals (POSs).

17. The method of claim 13, wherein the one or more devices each comprise an electronic game machine interface board (EGMIB), the EGMIB comprising logic, one or more interface boards, a processor, and on board memory, and wherein the EGMIB is configured to link the one or more devices to the server and to one another.

18. The method of claim 17, wherein the EGMIB comprises a slot machine interface board (SMIB).

19. The method of claim 13, further comprising a server internal voucher table that is stored on the server and/or the database.

20. The method of claim 19, wherein the internal voucher table of each of the one or more devices and/or server comprises information of issued and/or redeemed vouchers, wherein the information is of vouchers issued and/or redeemed on any of the one or more of the devices on the network.

21. The method of claim 13, wherein the one or more devices each comprise a set of pre-fetched validation IDs stored thereon, wherein an issued voucher generated while the server is offline is assigned a validation ID from the set of stored pre-fetched validation IDs.

22. The method of claim 21, wherein the set of pre-fetched validation IDs is generated by the server and communicated to and stored on the one or more devices upon connection to the server.

23. The method of claim 13, wherein upon the server receiving a redeemed voucher state communication from any one or more of the one or more devices, the server communicates a delete instruction to all the devices on the network, and wherein the redeemed voucher is removed from the internal voucher tables of all the devices on the network.

24. The method of claim 23, wherein only the server communicates the delete instruction.
